(19) United States
(12) Patent Application Publication
(10) Pub. No.: US 2005/0098236 A1
(43) Pub. Date: May 12, 2005

(54) Method and apparatus for cutting steel to reduce slag adherence

(76) Inventor: Claude Bissonnette, Cornwall (CA)

Correspondence Address: PEARNE & GORDON LLP, 1801 EAST 9TH STREET, SUITE 1200, CLEVELAND, OH, 44114-3108, US

(21) Appl. No.: 10/705,339

(22) Filed: Nov. 10, 2003

(51) Int. Cl. B23K 7/00

(52) U.S. Cl. 148/194

(57) ABSTRACT

A steel cutting apparatus includes a cutting torch that is moved in an arcuate path of constant radius so that a cutting flame of the cutting torch is always aimed at a fixed point in relation to a strand of steel at a cutting plane. Molten steel and iron oxide flow through a kerf in the steel toward a bottom corner of the strand, that is a center of the arcuate path. The rate of advance of the cutting torch along the arcuate path is controlled to compensate for at least a length of the path. The temperature of the strand in the path of the cutting flame, any edge of the strand in the path of the cutting flame, and a time remaining for cutting the strand can also be factors that influence the variable rate of advance of the cutting torch.

### FIELD OF THE INVENTION

The present invention relates to metallurgical products and processes, and more particularly to the cutting of steel to reduce the adherence of slag to cut edges.

### BACKGROUND OF THE INVENTION

In a continuous casting operation, a continuously cast strand is cut into lengths, such as billets, using an oxygen-fuel cutting torch system. Oxygen-fuel cutting torch systems are well known and are commonly used in a wide variety of cutting and welding applications. A cutting torch is mounted to move with the cast steel strand and to make a cross-cut through the strand perpendicular to its longitudinal axis, in its direction of movement.

As shown in FIGS. 1 and 2, a conventional steel billet cutting apparatus 10 is adapted to mount a cutting torch 12 for movement with an advancing continuous steel strand 14 (reference numeral 14 hereinafter indicates any one of a steel strand, billet, bloom or small slab). The apparatus 10 includes a pair of downwardly depending frames 16, which are pivotally connected together by a pivot pin 18 that act as a pair of clamp arms. A hydraulic cylinder 20 pivotally connects the respective upper ends 22 of the frames 16, in order to move clamping members 24 of the frames 16 into clamping engagement with vertical sides of the steel strand 14. The apparatus 10 is mounted for movement along a stationary track (not shown), which extends parallel to the longitudinal axis of the steel strand 14. When the frames 16 clamp the steel strand 14 between the clamping members 24, the advancing steel strand 14 moves the apparatus 10 along the stationary track. A cutting torch 12, shown in FIG. 2, is movable transversely across the steel strand 14 as indicated by arrow 28, and thereby cuts the strand 14 into billets. The transverse movement of the torch 12 is driven by a drive mechanism (not shown), which is adapted to mount on one of the frames 16 of the apparatus 10, so that the apparatus and the attached cutting torch 12 are maintained in a fixed longitudinal position relative to the moving steel strand 14, so that the cutting torch is moved over the steel strand 14 to sever the billet.

As the cutting flame 30 cuts through the strand 14, as shown in FIG. 2, molten steel and iron oxide flow downwardly between the faces 32 (only one of which is shown in FIG. 2) of the steel that define a kerf produced by the cutting flame 30. Some of the molten material adheres to and forms slag beads 34 along the lower cut edges 36. This slag must be removed; otherwise it adversely affects subsequent forming operations performed on the billets, which may cause defects in finished steel products made from the billets. For example, the slag beads may adhere to roller surfaces used for steel plate forming. Since the slag beads are much harder than the steel billet, the slag beads may form dimples in the rolled steel surface, or become embedded in the surface. Removing the slag beads from the billet in a secondary operation, such as scarfing, is tedious, time consuming and costly. Therefore, efforts have been made to immediately remove the slag accumulated during the cutting process.

In general, it is known that directing a fluid stream at the molten slag as it forms on the edges of the kerf tends to blow it away and thereby reduce its adherence. The fluid stream may comprise air, oxygen, water, mixtures thereof, or other gases or liquids. U.S. Pat. No. 4,336,078, entitled PROCESS AND APPARATUS FOR THE SEPARATION OF METALLURGICAL PRODUCTS, issued to Radtke on Jun. 22, 1982, for example, describes a process and apparatus for separating metallurgical products such as ingots, slabs or plate-shaped work pieces using a cutting torch deposed on one side of the product. As another example of prior art slag adherence reduction technology, U.S. Pat. No. 4,923,527, entitled APPARATUS AND METHOD FOR SLAG-FREE CUTTING OF BILLETS AND THE LIKE, issued to Ludwigson on May 8, 1990, describes a billet cutting apparatus of the type, which includes an oxygen-fuel cutting torch.

Applicant has invented a method and system for cutting such a continuously cast strand of steel or the like, which is taught in co-pending U.S. patent application Ser. No. 09/934701 entitled METHOD AND APPARATUS FOR CUTTING STEEL TO REDUCE SLAG ADHERENCE, the specification of which is incorporated herein by reference. The co-pending application describes several embodiments of an apparatus for cutting a strand of steel using an oxygen-fuel torch moved along a circular arc centered on a distal corner of the strand on the plane of cutting. The torch is moved along a predefined guide rail forming an arcuate path of a constant radius so that the torch is always aimed at a same point with respect to the strand, (e.g. the distal corner of the strand in the cutting plane). Subsequent experimentation has shown however, that certain refinements in the torch control are desirable for optimal results.

Accordingly there remains a need for a method and apparatus for cutting a steel strand at a variable rate to minimize adherence of slag.

### SUMMARY OF THE INVENTION

It is therefore an object of the invention to provide a method and apparatus for cutting steel with a cutting torch at a variable rate, while reducing slag adherence to a cut edge of the steel.

The variable rate of cutting compensates for at least an amount of steel traversed in a path made by a cutting flame of the cutting torch. The variable rate may further be changed in response to a time available for the cut.

It is another object of the invention to provide a drive system for cutting a steel strand to reduce slag adherence.

In accordance with one aspect of the present invention, a method is provided for cutting a strand of steel with a cutting torch to reduce slag adherence to a cut edge of the strand. The method involves steps of commencing a cut at a first side of the steel, and moving the cutting torch along an arcuate path at a variable rate that depends on a length of a path through the strand made by a cutting flame of the cutting torch, the arcuate path being of constant radius to continuously aim the cutting flame at a fixed point on the strand. The arcuate path is followed to keep the cutting flame aimed at the fixed point until the steel is cut.

When the steel strand has a bottom surface and a first side that meet at an angle that is not greater than 90°, it is preferable to place the corner of the strand defined between the first side and the bottom at the center of the arc formed by the arcuate support. The arcuate path has a constant radius and begins at a first position orientated substantially perpendicular to the bottom surface, and ends at a second position orientated substantially parallel to the bottom surface of the steel strand, so that the cutting flame of the cutting torch is continuously aimed at the distal corner of the cutting plane. By cutting in the arcuate path, the molten metal and iron oxide, under the force of the cutting flame, flow toward the distal corner, and substantially all of the molten metal and iron oxide drop off below the steel, leaving only a very small amount of slag bead that adheres to the bottom corner of the steel.

The movement of the cutting torch along the arcuate path is controlled so that when the cutting flame is directed along a relatively cool edge, or a relatively thick cross-section of the strand, the rate of advance is slower. Furthermore, when a corner of strand is being cut, the rate is slowed to ensure a clean cut is made. In general, the rate of movement of the cutting torch along the arcuate path is governed by a function of the temperature of the strand in the path of the cutting flame, a length of the path through the strand, and any edge on a surface of the strand in the path of the cutting flame.

In accordance with another aspect of the invention, an apparatus is provided for cutting steel to reduce slag adherence to the steel. The apparatus includes a cutting torch, a guide system for guiding the cutting torch along an arcuate path to ensure that a cutting flame of the cutting torch is always aimed at a bottom corner of the strand, and a drive system for controlling a variable rate of advance of the cutting torch along the arcuate path. The guide system may include an arcuate support that supports the cutting torch, and fixes the orientation of the cutting torch, so that it is continuously aimed at the bottom corner.

The drive system may include a drive shaft rotatably connected to the cutting torch to move the cutting torch along the arcuate support, and a frame to support the arcuate support and the drive system, as taught in the above identified co-pending United States patent application, in which case, a linkage system may be included in the drive system to convert a rotational movement of the drive shaft into the movement of the cutting torch along the arcuate support. In this embodiment of the present invention, a sleeve having an internally threaded bore is rotatably connected to the cutting torch about an axis perpendicular to both a plane determined by the arcuate support and a longitudinal axis of the sleeve. The drive shaft has a free end and a driven end, and is externally threaded with threads for engaging the internal threads of the bore. The drive shaft is pivotable about an axis perpendicular to the plane of the arcuate support passing through a universal joint at the driven end. Thus, when the drive shaft is rotated, the sleeve moves along the drive shaft, and causes the cutting torch to move along the arcuate support. The drive system may further include a servo mounted to the frame, the servo having a motor, a controller for controlling the motor inducing rotation of an axle, and the axle that is coupled to a gearbox that is connected to the universal joint. The servo may be water-cooled.

Alternatively the guide system may include the arcuate support to which the cutting torch is rigidly mounted. Tangential motion of the arcuate support therefore moves the cutting torch. If the arcuate support is of constant radius, and the cutting torch is secured radially inward, the tangential motion will ensure that the torch is continuously aimed at the center of a circle that defines an arc of the arcuate support. The tangential motion can be accomplished by a drive system including a rack secured to the arcuate support, for engaging a pinion driven by a servo as described above.

A structure for supporting the torch, guide system and drive system may be movable along a path parallel to the longitudinal axis of the strand, and may include a frame for releasably clamping the strand in a position in which a longitudinal axis of the steel is perpendicular to the plane determined by the arcuate support, as was described in the aforementioned co-pending application. The structure preferably also includes a weighted torch stabilizer that rests on the strand, the weighted torch stabilizer supporting the torch, guide system and drive system so that the arcuate support is in alignment with a desired cutting plane. The weighted torch stabilizer may include a guide surface for ensuring that its placement is centered on the strand, to compensate for a measure of lateral movement of the strand. The weighted torch stabilizer may further comprise a heat shield for protecting the drive system from heat of the strand and the cutting torch and splatter of molten material.

By clamping the frame and placing the weighted torch stabilizer onto the strand, the cutting apparatus can be moved together with the strand when, for example, the strand is a continuously cast strand exiting a caster. Accordingly the apparatus undergoes a cyclic process of clamping the strand at a cutting position, cutting the strand as the strand moves away from the caster, unclamping the strand, and moving to a next cutting position. The rate of production of the steel strand may depend on numerous factors, and the rate of cutting may vary in dependence on a duration of time available for the cut. In such cases, the rate of production governs the speed of the strand in the longitudinal direction, which, in turn, determines a length of time available for cutting. Accordingly if no measures are in place to synchronize the cutting cycle with the rate of production, a position of the cutting torch with respect to the caster wanders, resulting in inefficient use of the cutting torch, or incomplete cuts. A rate of production (or a travel speed of the strand) may therefore be monitored and used to control the variable rate of cutting of the strand.

Other advantages and features of the present invention will be better understood with reference to preferred embodiments of the present invention described hereinafter.

### BRIEF DESCRIPTION OF THE DRAWINGS

Having thus generally described the nature of the present invention, reference will now be made to the accompanying drawings, showing by way of illustration the preferred embodiments thereof, in which:

FIG. 1 is a front elevational view of a prior art apparatus for supporting a cutting torch to move with a continuously cast steel strand;

FIG. 2 is a schematic illustration of a prior art method of cutting a steel strand;

FIG. 3 is a front elevational view of an embodiment of a steel cutting apparatus, in accordance with an embodiment of the invention;

FIG. 4 is a schematic illustration of a variable-rate steel cutting cycle in accordance with the invention;

FIG. 5 schematically illustrates a side view of an embodiment of a steel cutting apparatus in accordance with the invention;

FIGS. 6a,b,c are three schematic illustrations of front elevational views of the steel cutting apparatus shown in FIG. 5, in three respective cutting positions;

FIG. 7 is a top elevational view of the steel cutting apparatus shown in FIG. 5 in a start position;

FIG. 8 is a top elevational view of the steel cutting apparatus shown in FIG. 5 in an end position; and

FIG. 9 is a schematic diagram of a servo in accordance with the invention.

It should be noted that throughout the appended drawings, like features are identified by like reference numerals.

### DETAILED DESCRIPTION OF THE PREFERRED EMBODIMENT

The invention provides a method and apparatus for cutting a steel strand at a variable rate in order to ensure a clean, even cut while reducing adherence of slag to cut edges. In this document, “steel strand” means any one of a steel strand, billet, bloom or slab.

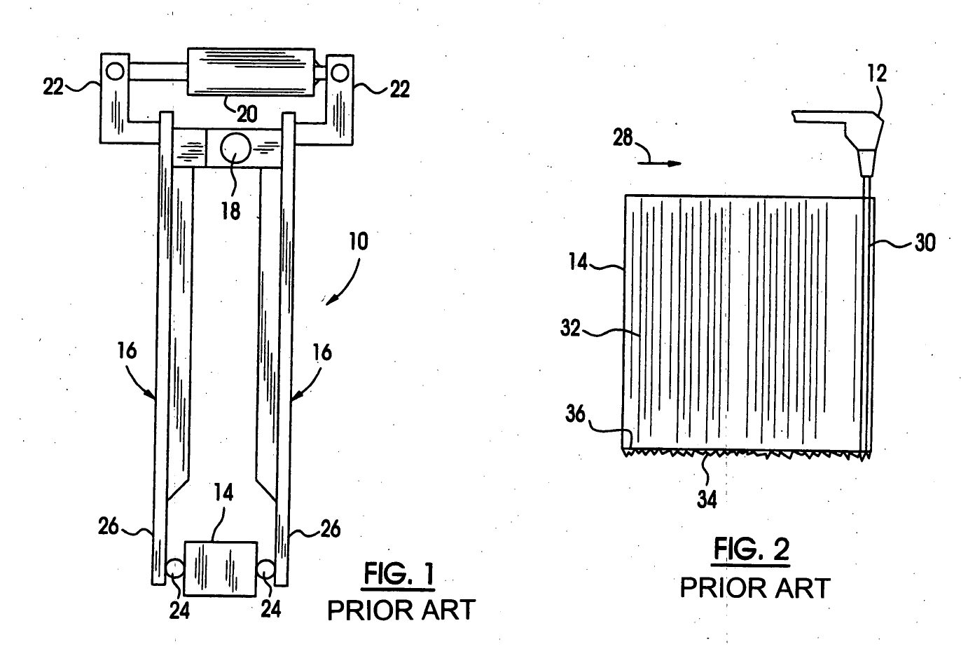

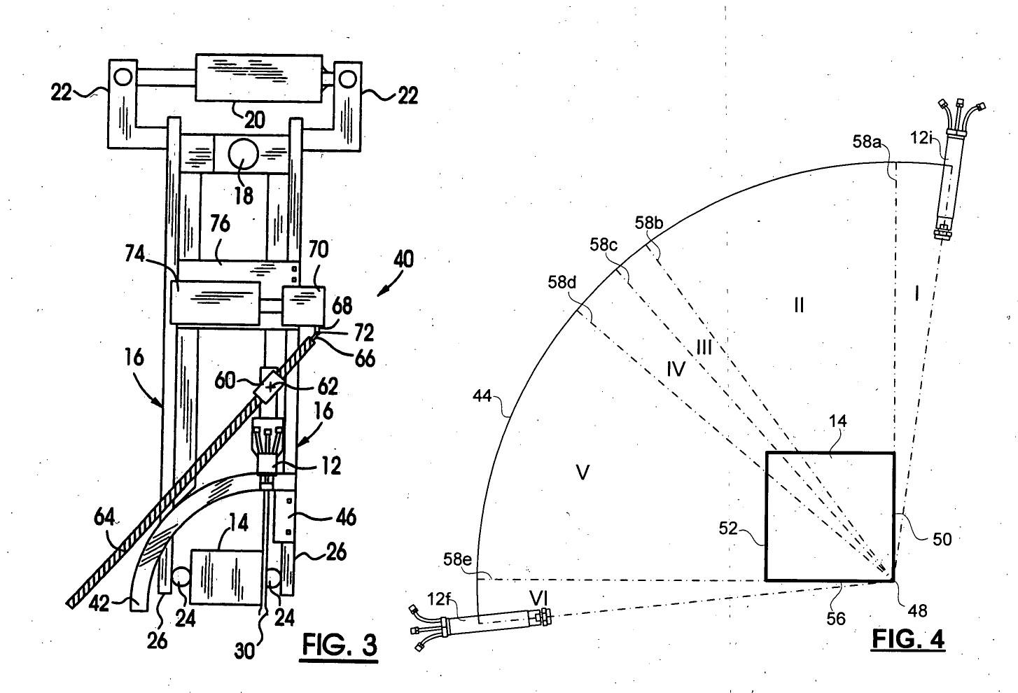

FIG. 3 illustrates a steel billet cutting apparatus 40 in accordance with an embodiment of the invention. The apparatus 40 is mounted to the frame 16 shown in FIG. 1, the parts of which are indicated by the same reference numerals and are therefore not described again. The apparatus 40 includes an arcuate support 42 forming an arcuate path 44, shown in FIG. 4. The arcuate support 42 is mounted at one end to one of the frames 16 by a mounting plate 46, at the lower end 26 of the frame 16, and above a top of the strand 14 when the strand is clamped between the frames 16.

As shown in FIG. 4, the arcuate path 44 formed by the arcuate support 42 is slightly greater than one quarter (90°) of a circular path centered at a fixed point at which a cutting flame of the torch is continuously aimed. In this example, the center of the circular path is located at a bottom corner 48 of the strand 14 (where a bottom edge 56 and a first side 50 meet). The arcuate path 44 defines a plane perpendicular to a longitudinal axis of the strand 14. The cutting torch 12 (FIG. 3) includes a mechanism for guiding the cutting torch 12 along the arcuate support 42. For example, rollers (not shown) operatively engage the arcuate support 42. Thus, as shown in FIG. 4, the cutting torch 12 begins by cutting the first side 50 of the strand 14 at the position and orientation of the cutting torch 12i, and ends the cut in a position and orientation of the cutting torch shown at 12f. As the cutting torch 12 moves in the arcuate path 44, the cutting flame 30 is always aimed at the bottom corner 48 of the cutting plane. The molten material therefore flows towards the bottom corner 48. Cutting the steel using this method results in a very small amount of slag forming on and adhering to the bottom corner 48 of the billet 14, rather than the significant amount that forms along the entire lower cut edge 36, as shown in FIG. 2, when the prior art, vertical, cutting cycle is used.

The cutting cycle between the start and end positions is not a linear progression at a predetermined cutting rate, but rather the rate of advance of the cutting torch along the arcuate path is governed by a function of the temperature and length of a path of the cutting flame through the strand. Further the existence of any edges of the strand may require a slower rate of advance to ensure a smooth cut through the strand 14. A function describing the rate as a function of time, servo position, or angle may be empirically derived, and is usually defined before commencing a cut. Accordingly the function may take into account such factors as a type of torch tip being used, the configuration of the cutting plane, etc. One embodiment of such a function is illustrated in FIG. 4.

The cutting cycle is divided into 6 phases. During a first phase (I), the cutting torch advances from the initial position and orientation to a vertical orientation 58a. During the phase I, the cutting torch 12 moves the slowest because the whole dimension of the strand 14 incident the cutting flame is a relatively cool edge, and because producing a smooth initial kerf requires significant heat.

The second phase (II) begins once the kerf is formed. The cutting torch 12 is advanced along the arcuate path 44 at a fastest rate. The actual speed of the fastest rate depends on properties of the torch (especially the configuration of the tip), depth of the strand, etc. During phase II, gravity assists the cutting torch in drawing the molten steel toward the corner 48. As the angle between the bottom edge 56 and the cutting flame is decreased, a length of the path incident the cutting flame jet is increased, and an increasing amount of the cold edge is cut, which may require a slower rate of advance rate, beginning with phase III.

The rate of advance of the cutting torch 12 is slowed down when the orientation 58b is reached, and phase III begins. The rate of advance is slowed throughout the phase III.

As will be appreciated by those skilled in the art, passing over the top corner of the strand may cause deflection of the cutting flame jet, besides the cutting flame is incident on a maximal length of the cutting path through the strand 14. Consequently, it is important to maintain the slower rate of advance of the cutting across the transition between the top and second side 52 of the steel strand, in phase IV.

Once the cut has passed the proximal corner by an acceptable margin, the cutting torch 12 passes the orientation 58d, and the rate of advance is increased to the highest speed, which is sustained throughout phase V. The length of the path through the strand 12 incident the cutting flame is decreasing in length throughout phase V. In part, this reduction of resistance to the cutting is offset by the need to push the molten material toward the bottom corner 48, as gravity is of decreasing assistance at these angles.

During the final phase VI, the cutting torch 12 slows down to allow the tip of the cutting torch 12 to cut the bottom edge, and to push some of the remaining slag down the substantially horizontal path of the cutting flame.

It will be appreciated by those skilled in the art that other cutting sequences may be used, depending on the rate of production of the strand, type and size of the cutting tip of the cutting torch, and a size, temperature, and cross-section of the strand or other steel mass being cut.

Other steel products, for example, blooms and small slabs, which generally have rectangular or square cross-sections, can also be cut in this manner to reduce slag adherence. The apparatus 40 may also be used to cut steel that has a non-rectangular cross-section. The cut can be effected by aiming the cutting flame 30 at a fixed point defined by a bottom corner of an imaginary square or rectangle drawn around the steel. Interchangeable arcuate supports 42 having different respective radii are preferably used to cut respective sizes of steel, in order to keep the arcuate path as short as possible for any given cutting operation.

The cutting torch 12 is moved by a drive mechanism operatively connected to the cutting torch 12 and preferably mounted to the same frame 16 to which the arcuate support 42 is mounted. In the embodiment shown in FIG. 3, the drive mechanism includes a sleeve 60 having internal threads (not shown), and a pivot member for rotatable connection to the cutting torch 12 at an axis 62 indicated by a “+”. The axis 62 is positioned perpendicular to both the plane determined by the arcuate support 42 and a threaded axial bore through the sleeve 60. The drive mechanism further includes a drive shaft 64 having a free end and an end connected by a universal joint 66 to a rotation-output shaft 68 of a gearbox 70. The drive shaft 64 has external threads for threadingly engaging the internal threads in the axial bore of the sleeve 60, so that rotation of the rotation-output shaft 68 moves the sleeve 60 along the drive shaft 64. As the sleeve 60 is moved along the drive shaft 64, the drive shaft 64 pivots about an axis 72 that extends to a middle of the universal joint 66. Movement of the sleeve 60 urges the cutting torch 12 along the arcuate support 42, and the drive shaft 64 pivots about the universal joint 66 because of the rigidity of the cutting torch 12, in a manner well known in the art.

The gearbox 70 is coupled to a servo 74, which controllably reciprocates the cutting torch 12 along the arcuate support 42. The gearbox 70 is required to convert the fixed angle output of the servo 74 into the required drive associated with the required motion of the cutting torch 12. The gearbox 70 is mounted to the frame 16 to which the arcuate support 42 is mounted, by a mounting plate 76. The drive mechanism and the arcuate support 42 do not interfere with the clamping action of the frames 16 because they are mounted to only one of the frames 16, in accordance with the illustrated embodiment.

In operation, the apparatus 40 is moved along the stationary track (not shown) to a predetermined start position when the hydraulic cylinder 20 is retracted to maintain the pair of frames 16 in an open position. A continuous steel strand 14 exiting a caster (not shown) advances between the open frames 16. When a predetermined length of the steel strand 14 has advanced beyond a point aligned with the cutting torch 12, the hydraulic cylinder 20 is extended to close the pair of frames 16, thereby clamping the steel strand 14 between the two clamping members 24. At this stage, the cutting torch 12 is preferably positioned at the initial position and orientation (12i), as shown in FIG. 4. The apparatus 40 moves forward with the continuous steel strand 14, and the servo 74 begins to rotate the drive shaft 64, thereby urging the cutting torch 12 along the arcuate support 42 while the cutting torch 12 is operated to produce a cutting flame 30, aimed at the bottom corner 48 of the steel strand 14. The multi-phase cutting procedure is applied as described above, and when the cutting operation is completed, the cutting torch 12 has reached the final position and orientation (12f), as shown in FIG. 4. The hydraulic cylinder 20 is again retracted to open the frames 16, and the apparatus 40 is moved back to the predetermined start position. Meanwhile, the servo 74 rotates the drive shaft 64 in the opposite direction, thereby returning the cutting torch 12 to the initial position and orientation, in preparation for a next cut.

The time it takes to cut the strand, and return to the starting position (i.e. the period of the cutting cycle) should be substantially the same as the time it takes to cast a strand of the given length to be cut. As will be understood by those with experience in the casting process, casting does not always proceed at the same rate. In order to ensure that clean, complete cuts are always achieved, it is desirable to control the cutting cycle period in accordance with the rate of production, or any other rate of advance of the strand. The rate of advance can be monitored using known devices, which may include passive sensors, that provide data to the controller of the servo 74. The data is used to systematically accelerate the variable rate cutting function, if required.

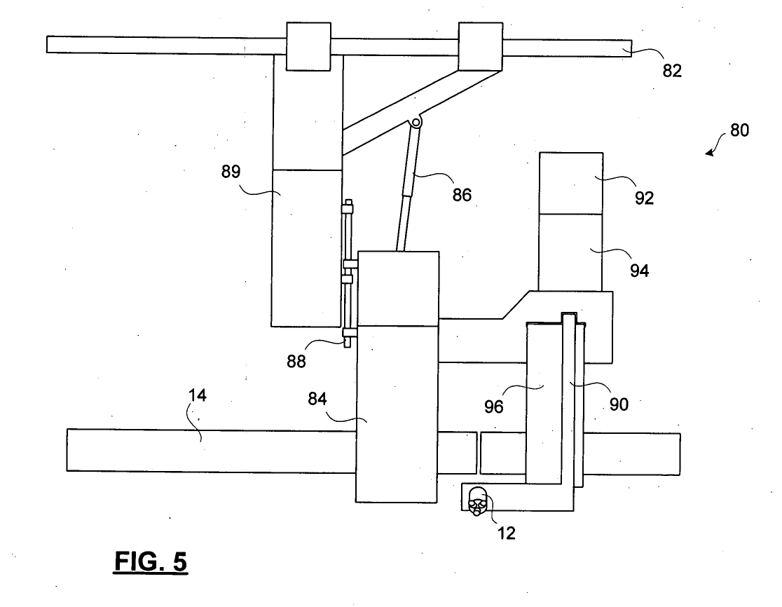

FIG. 5 is a schematic illustration of a side view of another embodiment of the invention. The illustration shows a cutting apparatus 80 in an end position, wherein a cut is complete. Accordingly, the cutting apparatus 80, that is supported by a rail 82, is in a protracted position, and a weighted torch stabilizer 84 rests on the strand 14. In accordance with the illust rated embodiment, a system for supporting and maneuvering the weighted torch stabilizer 84 includes a fluid cylinder 86, and a guide pin 88 that provides an axis for pivotally connecting the weighted torch stabilizer 84 to a support member 89, in a manner that permits controlled vertical movement of the weighted torch stabilizer 84. The support member 89 is rotatably secured to a support structure suspended from the rail 82. The action of the support member 89 is further described below with reference to FIG. 8. A spacing between hinge brackets of the weighted torch stabilizer 84 and support member 90 respectively permit the vertical movement of the weighted torch stabilizer 84, under the forces exerted by the fluid cylinder 86.

The weighted torch stabilizer 84 supports an embodiment of a drive system and a guide system not disclosed in the aforementioned co-pending application. The guide system is formed principally of an arcuate support 90 to which the cutting torch 12 is affixed, in a manner that ensures that the cutting flame of the: cutting torch 12 is directed radially inwardly with respect to the radius of the arcuate support 90. The arcuate support 90 is moved along the arcuate path 44 by the drive system.

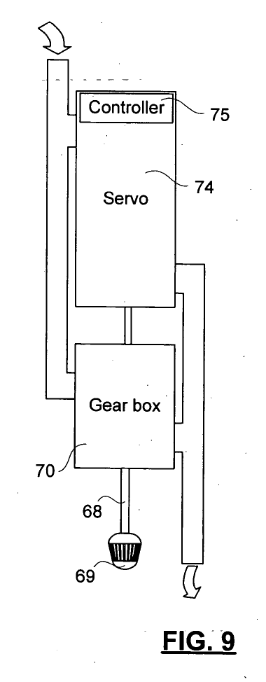

The drive system includes a rack affixed to a surface of the arcuate support 90 that engages a pinion (69 see FIG. 9). The pinion is indirectly driven by a servo 74 via a gearbox 70. Program instructions for a controller of the servo 74, optionally in conjunction with inputs from one or more travel speed sensors, are used to control a speed of rotation of an output axle of the servo, which is converted by the gearbox 70 into a position of the arcuate support 90. A heat shield 96 is further provided to reduce a temperature of the servo 74 and gearbox 70. In accordance with the illustrated embodiment, the heat shield moves with the arcuate support 90.

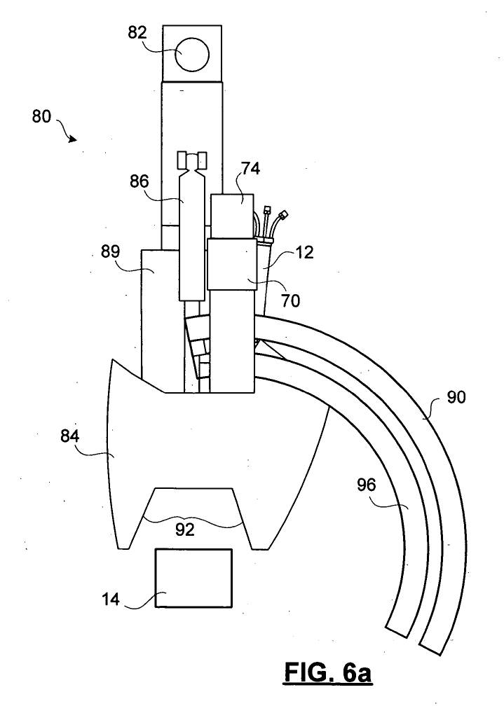

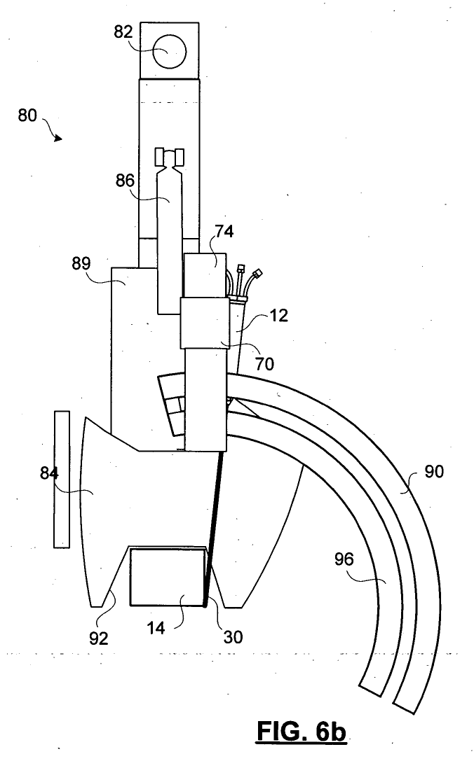

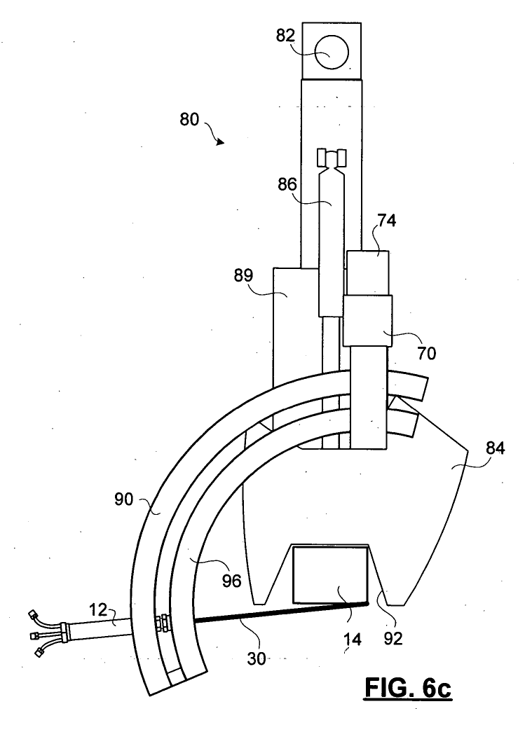

FIGS. 6a-c schematically illustrate a front elevational view of the embodiment of the invention shown in FIG. 5, at three stages in a cutting cycle. In FIG. 6a, the fluid cylinder 86 is retracted so that the weighted torch stabilizer 84 is suspended over the strand 14. The arcuate support 90 is in a start position with the cutting torch 12 in position and orientation 12i. In FIG. 6b, the weighted torch stabilizer 84 is placed on the strand 14 so that the arcuate support 44 is aligned with a desired cutting plane. The cutting torch 12 generates a cutting flame 30 that is directed to the bottom corner of the strand 14 incident the cutting plane. The cut is therefore begun, and the arcuate support 90 is in motion, driven by the servo 74 at a variable rate, until an end position and orientation 12f is reached, as illustrated in FIG. 6c.

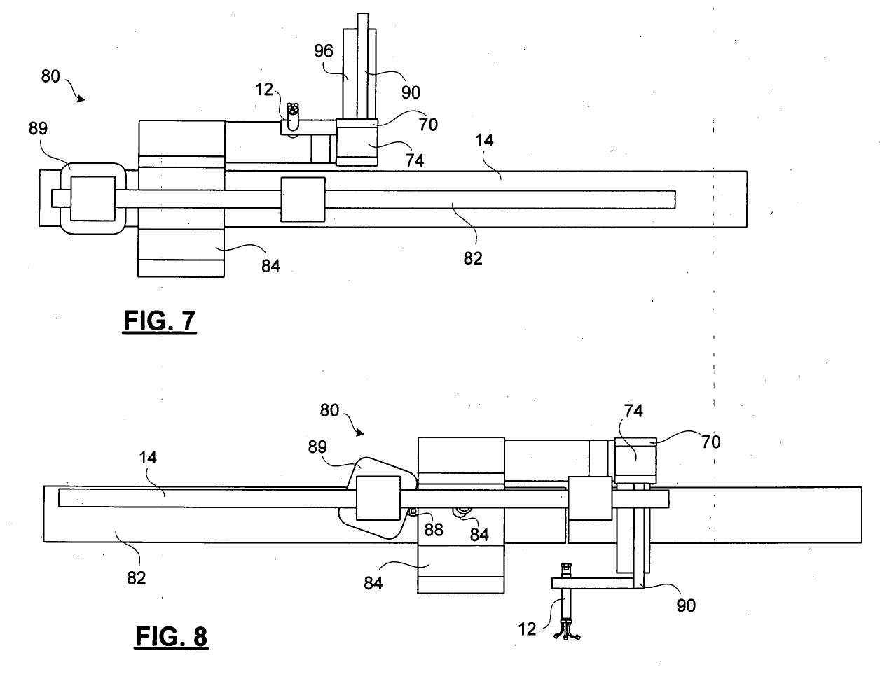

FIG. 7 schematically illustrates a top plan view of the cutting apparatus shown in FIG. 5, at the initial stage of operation illustrated in FIG. 6a. From the top view it is evident that the cutting torch 12, drive system, and guide system are connected to the weighted torch stabilizer 84. The longitudinal axis of the strand 14 is in vertical alignment with the center axis of the rail 82. This alignment is not always maintained. Most continuous casters cannot output precisely axially-aligned strands. It is therefore desirable to provide a mechanism for accommodating some measure of lateral offset of the strand 14.

FIG. 8 schematically illustrates a mechanism of the embodiment illustrated in FIG. 5, for accommodating lateral movement of the strand 14. The mechanism is provided by three cooperating features: the shape of the weighted torch stabilizer 84 shown in FIGS. 6a-c, which includes guiding surfaces 92 for guiding the centered placement of the weighted torch stabilizer 84 on the strand 14; a rotating coupling of the fluid cylinder 86 to the support structure suspended by the rail 82 connecting the cutting apparatus 80 to the rail 82; and a freely pivoting connection of the support member 89 to the support structure. When the longitudinal axis of the strand 14 is off-center with respect to the axis of the rail 82, the deposition of the weighted torch stabilizer 84 induces a shearing force across the guide pin 88, causing the support member 89 to rotate, as the weighted torch stabilizer 84 is lowered. The rotation of the support member 89 aligns the weighted torch stabilizer 84 with the strand 14, and the cutting torch 12, drive system and guide system, rigidly connected to the weighted torch stabilizer 84, are thereby maneuvered to an accurate start position with respect to the strand 14.

FIG. 9 schematically illustrates the servo 74 and gearbox 70 connected to the pinion 69. The servo 74 and gearbox 70 are preferably water-cooled. As will be appreciated by those skilled in the art, the equipment used in the apparatus 40 for cutting steel is subjected to elevated temperatures. In accordance with the invention, the rate of advance of the cutting torch is controlled. The controller may be purely mechanical or an electronic control device, like a controller 75 for the servo 74. One reason for using the controller 75 is to permit adjustments to the duration of the respective cutting phases in response to environmental changes, and to minimize the labor associated with changing the cutting cycle to cut strands of different dimensions. Electronics are temperature sensitive, and need to be maintained within a predefined operating temperature range in order to function. While the heat shield 96 deflects or absorbs heat and any splattered molten material that might otherwise damage the servo 74, gearbox 70, or other parts of the drive system, the servo 74 and gearbox 70 is preferably water-cooled. Accordingly coolant input duct 78, and coolant output duct 79, are provided. The input duct 78 conveys cool water to the servo 74 and gearbox 70.

The servo 74 includes the controller 75 that is adapted to receive servo position feedback, to store program instructions that encode the function that controls to the rate of advance of the cutting torch as a function of position for the particular strand, the properties of the cutting torch, etc.

Modifications and improvements to the above-described embodiments of the invention may become apparent to those skilled in the art. For example, although the apparatus has been described with reference to the cutting of continuously cast strands, the cutting apparatus 40,80 described with reference to FIGS. 3, and 5 respectively may likewise be used to cut stationary steel strands, billets, blooms or slabs. For stationary cutting applications, the apparatus 40,80 may be mounted to a stationary base and the steel to be cut may be moved into position so that the desired cutting plane is parallel with the plane of the arcuate support using any one of many known heavy material manipulators. Alternatively, the apparatus 40,80 may be mounted to a mobile base that is rolled or driven into position over the piece to be cut.

The foregoing description is therefore intended to be exemplary rather than limiting. The scope of the invention is therefore intended to be limited solely by the scope of the appended claims.

1. A method of cutting a strand of steel with a cutting torch, comprising:
commencing a cut at a first side of the strand;
moving the cutting torch along an arcuate path at a variable rate that depends on at least a length of a path through the strand made by a cutting flame of the cutting torch, the arcuate path being of constant radius to continuously aim the cutting flame at a fixed point on the strand; and
following the arcuate path to keep the cutting flame aimed at the fixed point until the steel is cut.

2. The method as claimed in claim 1 wherein moving at the variable rate further comprises moving the cutting torch along the arcuate path at a rate dependent on a location of an edge of a surface of the strand in the path of the cutting flame.

3. The method as claimed in claim 2 further comprising an initial step of securing a cutting apparatus to the strand for the duration of a cut, the securing comprising:
clamping a frame to the strand; and
placing a weighted torch stabilizer onto the strand, the weighted torch stabilizer supporting the cutting torch and a drive system for moving the cutting torch along the arcuate path.

4. The method as claimed in claim 3 wherein placing the weighted torch stabilizer comprises lowering the weighted torch stabilizer over a top of the strand and permitting a guiding surface of the weighted torch stabilizer to center the weighted torch stabilizer on a top of the strand.

5. The method as claimed in claim 2 further comprising monitoring a travel speed of the strand, and adjusting a cutting cycle period to optimize cutting given a current travel speed.

6. The method as claimed in claim 2 wherein the moving the cutting torch at a variable rate further comprises controlling advancement of the cutting torch along the arcuate path at a variable rate determined by program instructions read by a controller of a servo motor.

7. The method as claimed in claim 2 wherein the moving the cutting torch at a variable rate further comprises tangentially moving an arcuate support of constant radius to which the cutting torch is rigidly connected.

8. The method as claimed in claim 7 wherein tangentially moving comprises controlling -output of a servo motor to rotate a pinion that engages a rack on the arcuate support.

9. A method as claimed in claim 8 further comprising a step of circulating water around the servo motor to cool it.

10. An apparatus for cutting a strand of steel to reduce adherence of slag to the cut steel, comprising:
a cutting torch;
a guide system for moving the cutting torch in an arcuate path of constant radius so that a cutting flame of the cutting torch is continuously aimed at a fixed point in relation to the strand; and
a drive system for advancing the cutting torch along the arcuate path at a variable rate that depends on at least a length of a path through the strand made by a cutting flame of the cutting torch.

11. An apparatus as claimed in claim 10 wherein the drive system comprises a controller for controlling a rate of the advance along the arcuate path in dependence on the length of the path of the cutting flame through the strand, and any edge on a surface of the strand in the path of the cutting flame.

12. An apparatus as claimed in claim 11 wherein the controller is an electronic device adapted to store program instructions, and controls the rate of advance of the cutting torch.

13. An apparatus as claimed in claim 12 wherein the electronic device further receives an indicator of a rate of advance of the strand, and optimizes cutting of the strand given available time to complete the cut through the strand.

14. An apparatus as claimed in claim 11 wherein the guide system comprises an arcuate support forming the arcuate path for guiding the-cutting torch movement.

15. An apparatus as claimed in claim 14 wherein the guide system further comprises a heat shield for protecting the drive system from heat of the strand and the cutting torch, and splatter of molten material.

16. An apparatus as claimed in claim 15 wherein the drive system comprises a rack mounted on the arcuate support and a pinion driven by a servo comprising a motor, a controller, and a gearbox.

17. An apparatus as claimed in claim 16 wherein the servo further comprises a coolant input duct and a coolant output duct to permit water cooling of the servo.

18. A method of cutting a continuously cast strand of steel with a cutting torch, comprising:
moving the cutting torch along with the continuously cast strand as it advances;
commencing a cut at a first side of the continuously cast strand; and
moving the cutting torch along an arcuate path at a variable rate that depends on at least a length of a path through the strand made by a cutting flame of the cutting torch, the arcuate path being of constant radius to continuously aim the cutting flame at a fixed point on the continuously cast strand until the continuously cast strand is cut.

19. The method as claimed in claim 18 further comprising controlling the variable rate to ensure that the torch is moved more slowly when a corner of the continuously cast strand is coincident with the arcuate path.

20. The method as claimed in claim 19 further comprising receiving input from sensors to determine a rate of advance of the continuously cast strand, and adjusting the variable rate to ensure that the continuously cast strand is cut before the continuously cast strand has moved a predetermined distance.
